(19) United States
(12) Patent Application Publication
(10) Pub. No.: US 2016/0300100 A1
(43) Pub. Date: Oct. 13, 2016

(54) IMAGE CAPTURING APPARATUS AND METHOD

(71) Applicant: INTEL CORPORATION, Santa Clara, CA (US)

(72) Inventors: Xiaolu SHEN, Beijing (CN); Lidan ZHANG, Beijing (CN); Wenlong LI, Beijing (CN); Yangzhou DU, Beijing (CN); Fucen ZENG, Beijing (CN); Qiang LI, Beijing (CN); Xiaofeng TONG, Beijing (CN)

(21) Appl. No.: 14/775,387

(22) PCT Filed: Nov. 10, 2014
(86) PCT No.: PCT/CN2014/090711

§ 371 Date: Sep. 11, 2015

(51) Int. Cl. G06K 9/00; G06K 9/20; G06K 9/46

(52) U.S. Cl. CPC G06K 9/00248; G06K 9/4604; G06K 9/20; G06K 9/00335

(57) ABSTRACT

Apparatuses, methods and storage medium associated with capturing images are disclosed herein. In embodiments, the apparatus may include a face tracker to receive an image frame, analyze the image frame for a face, and on identification of a face in the image frame, evaluate the face to determine whether the image frame comprises an acceptable or unacceptable face pose. Further, the face tracker may be configured to provide instructions for taking another image frame, on determination of the image frame having an unacceptable face pose, with the instructions designed to improve likelihood that the other image frame will comprise an acceptable face pose. Other embodiments may be described and/or claimed.

### TECHNICAL FIELD

The present disclosure relates to the field of imaging. More particularly, the present disclosure relates to image capturing apparatus and method.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Face related application takes facial image as input, and extracts information like identity, expression or age for some purposes. Accuracy of such information highly relies on the quality of the facial image, where partial or large-angle face generally should be avoided. To facilitate capturing of facial images with appropriate quality, many image capturing devices or applications provide some form of guidance. For example, some image capturing devices or applications draw some markers on the camera preview screen to guide the end user, allowing the end user to align his/her face with the markers. This method requires some effort to follow, which may be hard for children or elderly users. In addition, it does not allow for rotation or expression, which is not particularly helpful for animation or photo enhancement applications.

Further, users often would like to share an image or an avatar animation image with exaggerated or funny expression in messaging or as personalized face icons. The expressive expressions may include e.g., exaggerated laughing, being surprised, or any other funny facial expressions. The current approach is to use professional video editing software to pick out these interesting moments from the input or generated avatar video. However, since these special moments, typically, occur infrequently, and in short periods of time, the current approach is not very user friendly for the average users.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a block diagram of an example imaging device, according to the disclosed embodiments.

FIG. 2 illustrates various maneuvering of an imaging device, according to the disclosed embodiments.

FIG. 3 illustrates example user instructions for capturing image frames with better face poses, according to the disclosed embodiments.

FIG. 4 illustrates a process for capturing an image frame with an acceptable face pose, according to the disclosed embodiments.

FIG. 5 illustrates two image frames taken without and with user instructions, according to the disclosed embodiments.

FIG. 6 illustrates an example process for automatically capturing snapshots, according to the disclosed embodiments.

FIG. 7 illustrates another example process for automatically capturing snapshots, according to the disclosed embodiments.

FIG. 8 illustrates an example computer system suitable for use to practice various aspects of the present disclosure, according to the disclosed embodiments.

FIG. 9 illustrates a storage medium having instructions for practicing methods described with references to FIGS. 1-7, according to disclosed embodiments.

### DETAILED DESCRIPTION

Apparatuses, methods and storage medium associated with capturing images are disclosed herein. In embodiments, an apparatus may include a face tracker to receive an image frame, analyze the image frame for a face, and on identification of a face in the image frame, evaluate the face to determine whether the image frame comprises an acceptable or unacceptable face pose. Further, the face tracker may be configured to provide instructions for taking another image frame, on determination of the image frame having an unacceptable face pose, with the instructions designed to improve likelihood that the other image frame will comprise an acceptable face pose. In embodiments, the image frame may be received from an image capturing engine (e.g., a camera), and the apparatus may further comprise the image capturing engine.

In embodiments, an apparatus may include a face tracker to receive an image frame, analyze the image frame for a face, and on identification of a face in the image frame, extract a face shape of the face or determine a facial expression of the face. Further, the face tracker may be configured to make a determination on whether to add the image frame to a collection of snapshots. The determination may be based at least in part on the extracted face shape or the determined facial expression of the face in the image frame. In embodiments, the image frame may be received from an image capturing engine (e.g., a camera) or an image generating engine (e.g., an animation-rendering engine), and the apparatus may further comprise the image capturing and/or generating engine.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

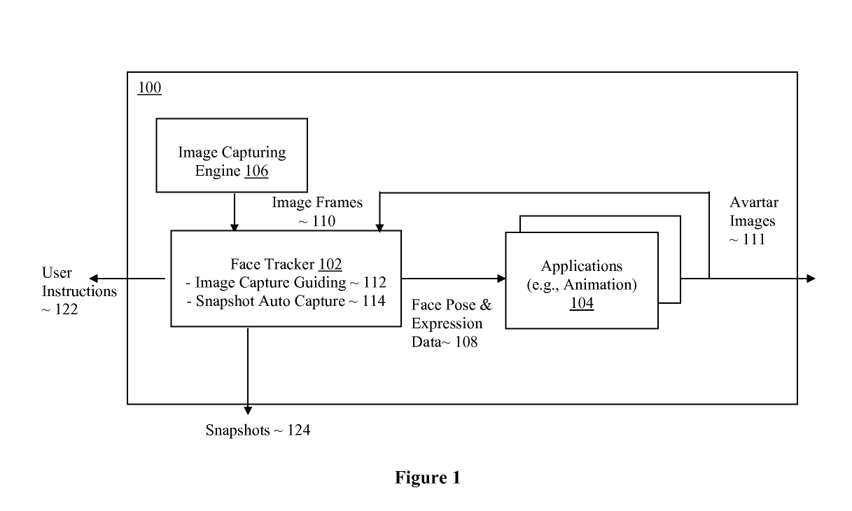

Referring now to FIG. 1, wherein an imaging device, according to the disclosed embodiments, is shown. As illustrated, for the embodiments, imaging device 100 may include face tracker 102, one or more applications 104, and image capture engine 106, coupled with each other as shown. Face tracker 102 may be configured to receive image frame 110 from image capturing engine 106, analyze image frame 110 for a face, and identify landmarks, facial expressions (such as eye and/or mouth movements) in the face. Face tracker 102 may be configured to output face pose and expressions data 108 for applications 104, for use by applications 104. An example of applications 104 may include, but is not limited to, an animation-rendering engine 104 configured to animate one or more avatars based at least in part on the face pose and expression data 108.

Additionally, face tracker 102 may include image capture guiding function 112 configured to evaluate the face to determine whether image frame 110 comprises an acceptable or unacceptable face pose, on identification of a face in image frame 110. Further, image capture guiding function 112 may be configured to provide instructions 122, e.g., to a user, for taking another image frame, on determination of image frame 110 having an unacceptable face pose. The instructions may be designed to improve the likelihood that the next image frame 110 will comprise an acceptable face pose. In embodiments, image frame 110 may be received from an image capturing engine 106. An example of image capturing engine 106 may include, but is not limited to, a camera.

Still further, face tracker 102 may further include snapshot auto capture function 114 configured to extract a face shape of a face or determine a facial expression of a face, on identification of the face in image frame 110, and make a determination on whether to add image frame 110 (or an avatar image 111 generated based on face pose and expression data 108 of image frame 110) to a collection of snapshots (not shown). The determination may be made based at least in part of the extracted face shape or the determined facial expression of the face in image frame 110. In embodiments, image frame 110 may be received from image capturing engine 106 (e.g., a camera), and avatar image may be received from an application 104 (such as, an avatar animation-rendering engine). An avatar animation-rendering engine/application 104 that generates images may also be referred to as an image generating engine.

Except for image capture guiding function 112, and snapshot auto capture function 114, which will be described in further detail below, face tracker 102 may be any one of a number of known face tracker including, but is not limited to, the facial mesh tracker disclosed in PCT Application PCT/CN2014/073695, entitled FACIAL EXPRESSION AND/OR INTERACTION DRIVEN AVATAR APPARATUS AND METHOD, filed on Mar. 19, 2014. In embodiments, the face mesh tracker of PCT/CN2014/073695 may include a face detection function block to detect a face through window scan of one or more of a plurality of image frames, and a landmark detection function block to detect landmark points on the face. In embodiments, it may also include an initial face mesh fitting function block to initialize a 3D pose of a face mesh based at least in part on a plurality of landmark points detected on the face, a facial expression estimation function block to initialize a plurality of facial motion parameters based at least in part on a plurality of landmark points detected on the face, a head pose tracking function block to calculate rotation angles of the user's head, based on a subset of sub-sampled pixels of the plurality of image frames, a mouth openness estimation function block to calculate opening distance of an upper lip and a lower lip of the mouth, based on a subset of sub-sampled pixels of the plurality of image frames, a facial mesh tracking function block to adjust position, orientation or deformation of a face mesh to maintain continuing coverage of the face and reflection of facial movement by the face mesh, a tracking validation function block to monitor face mesh tracking status, to determine whether it is necessary to relocate the face, a mouth shape correction function block to correct mouth shape, through detection of inter-frame histogram differences for the mouth, an eye blinking detection function block to estimate eye blinking, a face mesh adaptation function block to reconstruct a face mesh according to derive facial action units, and re-sample a current image frame under the face mesh to set up processing of a next image frame, or a blend-shape mapping function block to convert facial action units into blend-shape coefficients for the animation of the avatar. It may be implemented with Application Specific Integrated Circuits (ASIC), programmable circuits programmed with the implementation logic, software implemented in assembler languages or high level languages compilable into machine instructions supported by underlying general purpose and/or graphics processors.

Applications 104, as alluded to earlier, may be any one of a number of known applications that can use face pose and expression data 108 provided by face tracker 102. In particular, one of applications 104 may be an image generating engine such as the avatar animation-rendering engine disclosed in PCT Application PCT/CN2014/087248, entitled USER GESTURE DRIVEN AVATAR APPARATUS AND METHOD, filed on Sep. 26, 2014. In embodiments, the avatar animation-rendering engine of PCT/CN2014/087248 may be configured to animate a canned facial expression by blending first one or more pre-defined shapes into a neutral face during a start period, further blending or un-blending second one or more pre-defined shapes into the canned facial expression to animate the facial movements of the canned facial expression for the duration during a keep period, and un-blending the first or second one or more pre-defined shapes to return the avatar to the neutral face during an end period. Similarly, image capturing engine 106 may be any one of a number of known image capturing engines.

While for completeness, embodiments of imaging device 100 has been described as having applications 104 and image capturing engine 106, in alternate embodiments, imaging device 100 may be practiced without applications 104 (including image generating applications) and/or image capturing engine 106. Imaging device 100 with image capturing engine 106, and not image generating applications 104 may also be referred to as an image capturing device. Similarly, imaging device 100 with an image generating application 104, and not image capturing engine 106 may be referred to as an image generating device. Thus, image device 100 may also be referred to as image capturing or generating device. Except for face tracker 102 having image capture guiding function 112 and snapshot auto capture function 114, imaging device 100 may be a wide range of known imaging devices including, but are not limited to, wearable computing devices, smartphones, computing tablets, e-books, notebook computers, laptop computers, and so forth, equipped with image capturing engine and/or image generating applications.

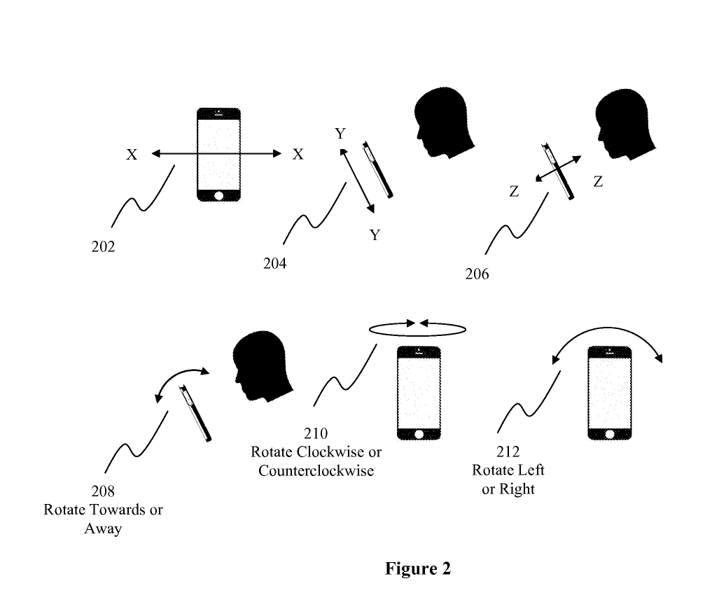

Referring now to FIG. 2, wherein various maneuvering of an imaging device, according to the disclosed embodiments, is shown. As illustrated, an imaging device (such as a smartphone) with an image capturing engine (such as a camera) may be moved in a positive or negative direction along an X-axis, a Y-axis and/or a Z-axis, 202, 204 and 206. The imaging device may also be rotated towards or away from the user 208, in a clockwise or counterclockwise direction 210, and/or to the left or right 212.

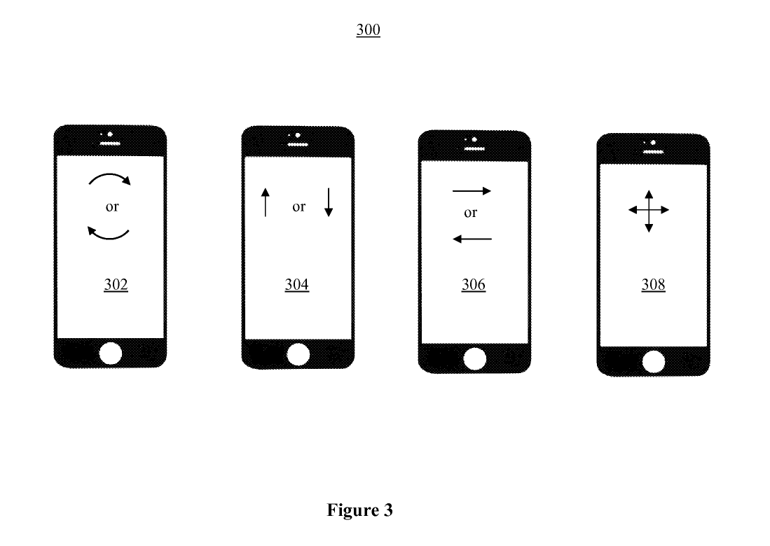

Referring now to FIG. 3, wherein example user instructions for capturing image frames with better face poses, for an imaging device with maneuverability of FIG. 2, according to the disclosed embodiments, is shown. As illustrated, the instructions may include simple, easy-to-understand graphics, such as arrows in the form of arcs 302 to instruct e.g., a user, to move imaging device 100 in a clockwise or counterclockwise direction. Additionally, the instructions may include up and down arrows 304 to instruct e.g., a user, to move imaging device 100 in a positive Y or negative Y direction, or horizontal arrows 306 to instruct e.g., a user, to move imaging device 100 in a positive X or negative X direction. Further, the instructions may include arrows in the form of a cross 308 to instruct e.g., a user, to rotate imaging device 100 towards or away from a user, in a clockwise or counterclockwise direction, or towards the left or right, as earlier described with reference to FIG. 2. These example instructions are meant to be illustrative and non-limiting. It is anticipated that a wide range of simple and easy-to-understand graphics and/or textual instructions may be provided to guide a user in moving or rotating imaging device 100, such that the likelihood of the face pose of the next captured image will improve may increase.

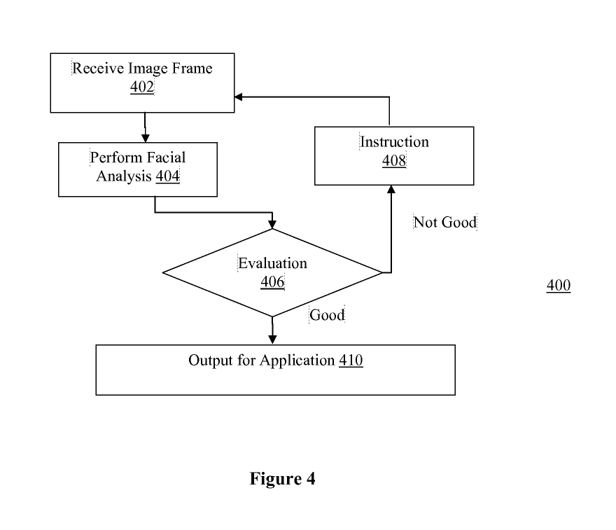

Referring now to FIG. 4, wherein a process for capturing an image frame with an acceptable face pose, according to the disclosed embodiments, is shown. As illustrated, process 400 for capturing an image frame with an acceptable face pose may include operations performed in blocks 402-410. The operations may be performed e.g., by the earlier described face tracker 102 with image capture guiding function 112.

Process 400 may start at block 402. At block 402, as earlier described, an image frame may be received. At block 404, analysis may be performed against the image frame, to identify a face in the image frame. On identification of a face, landmarks and/or facial expressions (such as eye and/or mouth movements) may be identified. Various methods may be used to identify the facial landmark positions including, but are not limited to, the supervised descent method, the active appearance models, and so forth. For further information on the “supervised descent method,” see e.g., Xiong, Xuehan, and Fernando De la Torre. “Supervised descent method and its applications to face alignment.” Computer Vision and Pattern Recognition (CVPR), 2013 IEEE Conference on. IEEE, 2013. For further information on “active appearance models,” see e.g., Cootes, Timothy F., Gareth J. Edwards, and Christopher J. Taylor. “Active appearance models.” IEEE Transactions on pattern analysis and machine intelligence 23.6 (2001): 681-685. From block 404, process 400 may proceed to block 406.

At block 406, the face pose may be evaluated. In embodiments, the evaluation may include computation of a number of translation positions along the x, y and z axes, tx, ty, tz, and angle positions of rotation around the x, y and z axes, rx, ry, rz, for the face pose. Various method may be utilized to compute tx, ty, tz, and rx, ry, rz, including, but are not limited to a model based approach, a Perspective n point (pnp) problem approach. For further information on a “model based” approach, see e.g., Dementhon, Daniel F., and Larry S. Davis. “Model-based object pose in 25 lines of code.” International journal of computer vision 15.1-2 (1995): 123-141. For further information on a pnp problem approach, see e.g., Lepetit, Vincent, Francesc Moreno-Noguer, and Pascal Fua. “Epnp: An accurate o (n) solution to the pnp problem.” International journal of computer vision 81.2 (2009): 155-166.

Thereafter, tx, ty, tz, and rx, ry, rz, may be compared to corresponding reference ranges to determine if the quantities are within or outside the reference ranges, position (tx₁, tx₂, ty₁, ty₂, tz₁, tz₂) and angle (rx₁, rx₂, ry₁, ry₂, rz₁, rz₂) as follows:
tx₁<=tx<=tx₂ and
ty₁<=ty<=ty₂ and
tz₁<=tz<=tz₂ and
rx₁<=rx<=rx₂ and
ry₁<=ry<=ry₂ and
rz₁<=rz<=rz₂

In embodiments, a face pose may be considered acceptable or good, if tx, ty, tz, and rx, ry, rz, are all within the reference ranges, otherwise, the face pose may be considered not acceptable or not good.

If the face pose is considered not acceptable or not good, process 400 may proceed from block 406 to block 408. At block 408, instructions may be given to guide the user in moving imaging device 100 and take at least another image frame. The instructions, e.g., moving imaging device 100 in a positive or negative direction along an X, Y and/or Z axis, closer or away from the user, clockwise or counterclockwise, tilting left or right and so forth, may be provided, based at least in part on the amounts the various reference ranges are exceeded.

In embodiments, a six dimensional data structure, tx, ty, tz, and rx, ry, rz, having various instructions for moving imaging device 100 in a positive or negative direction along an X, Y and/or Z axis, closer or away from the user, clockwise or counterclockwise, tilting left or right and so forth, for various excess amounts may be pre-configured/maintained, e.g., by image capture guiding function 112.

Operations at blocks 402-408 may be repeated a number of times, until eventually, the result of the evaluation at block 406 indicates that the face pose is acceptable or good. At such time, process 400 may proceed from block 406 to block 410. At block 410, the image frame with the acceptable or good face pose may be output, e.g., for one or more applications 104.

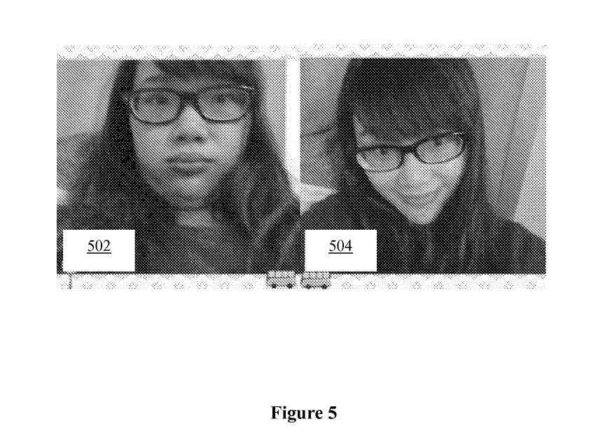

FIG. 5 illustrates two image frames taken without and with user instructions, according to the disclosed embodiments. More specifically, image frame 502 is taken without guidance, resulting in a face pose that is not acceptable or not good. Image frame 504 is a subsequent re-take following the instructions provided to move imaging device 100, resulting in a face pose that is acceptable or good.

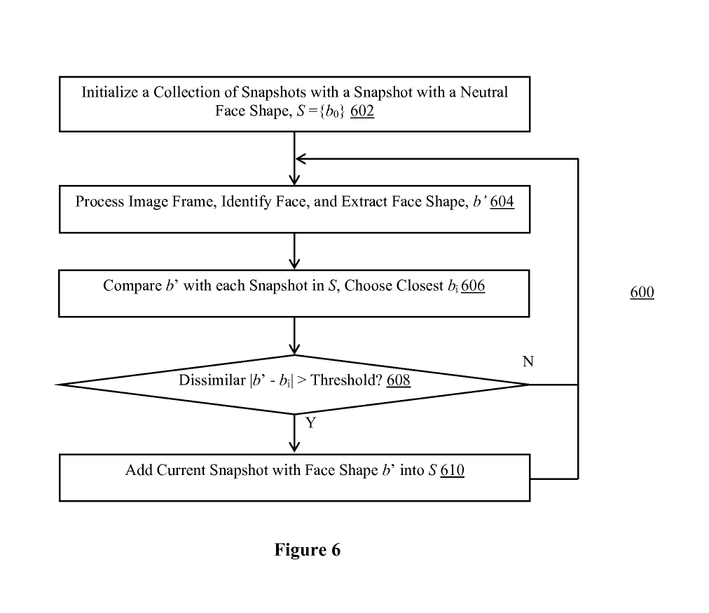

Referring now to FIG. 6, wherein an example process for automatically capturing snapshots, according to the disclosed embodiments, is shown. As illustrated, in embodiments, process 600 for automatically capturing snapshots may include operations performed at blocks 602-610. The operations may be performed e.g., by the earlier described snapshots auto capture function 114.

Process 600 may begin at block 602. At block 602, a collection of snapshots (S) of user or avatar images may be initialized with a snapshot with a neutral face shape b₀. The collection may be initialized e.g., at a user's request, during a user registration, and so forth. At block 604, a current image frame, e.g., a current image frame captured by image capturing engine 106 may be processed and analyzed to identify a face. Further, on identification of a face, the face shape of the face b′ may be extracted.

Next, at block 606, the face shape b of the face in the current image frame may be compared with face shapes of the faces of the snapshots in the collection S, to select a snapshot with face that has the closest face shape bᵢ. At block 608, a determination may be made on whether the current image frame should be considered as similar or dissimilar to the closest snapshot selected. The determination may be made e.g., based on a dissimilarity measure. In embodiments, the dissimilarity measure may be the absolute distance between b′ and bᵢ, i.e., |b′−bᵢ|. The current image frame may be considered to be dissimilar to the closest selected snapshot if |b′−bᵢ| is greater than a threshold, otherwise, the current image frame and the closest selected snapshot may be considered as similar.

On determining that the current image frame and the closest selected snapshot are dissimilar, process 600 may proceed from block 608 to block 610. At block 610, the current image frame (and/or an avatar image generated based on the face pose and expression data of the image frame) may be automatically added to the collection of snapshots. On the other hand, on determining that the current image frame and the closest selected snapshot are similar, process 600 may return to block 604, and continue therefrom as earlier described to analyze a next image frame. Operations at bock 604 to block 608 may be repeated any number of times for as long as there are image frames being captured/generated.

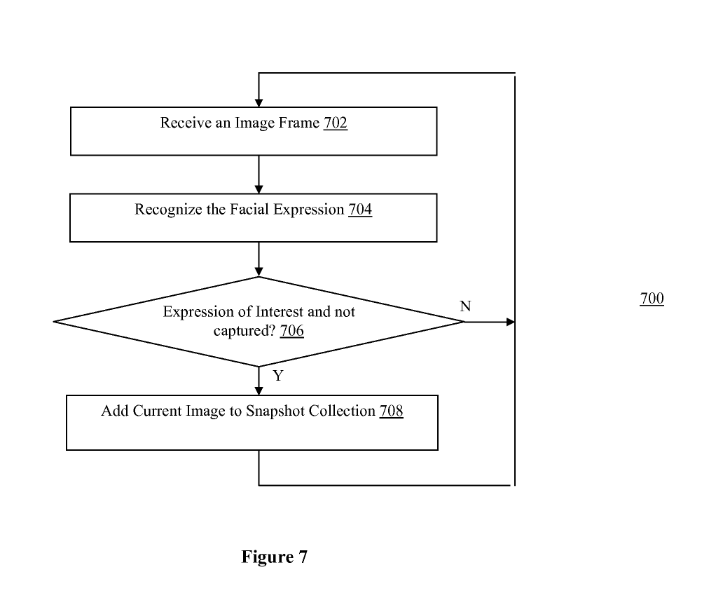

Referring now to FIG. 7, wherein another example process for automatically capturing snapshots, according to the disclosed embodiments, is shown. As illustrated, in embodiments, process 700 for automatically capturing snapshots may include operations performed at blocks 702-708. The operations may be performed e.g., by the earlier described snapshots auto capture function 114.

Process 700 may start at block 702. At block 702, an image frame may be received. As described earlier, the image frame may be received e.g., from image capturing engine 106. At block 704, the image frame may be processed and analyzed to identify a face. Further, the face may be analyzed for facial expression, such as eye and/or mouth movements, head pose, and so forth.

At block 706, a determination may be made on whether the facial expression is a facial expression of interest that a collection of snapshots does not have of the user or an avatar. Examples of facial expression of interest may include, but are not limited to, facial expressions with exaggerated eye and/or mouth movements, tongue-out, big smiles, grin, and so forth. The facial expression of interest may be pre-defined and maintained in a facial expression of interest list. Similarly, corresponding lists may be maintained to track whether snapshots of a user or an avatar with the facial expressions of interest have been previously captured and saved into the collection of snapshots.

On determining that the current image frame has a face with facial expression of interest, and a snapshot of a user or avatar with such facial expression had not been previously captured, process 700 may proceed from block 706 to block 708. At block 708, the current image frame (and/or an avatar image generated based on face pose and expression data of the image frame) may be automatically added to the collection of snapshots. On the other hand, on determining that either the current image frame does not have a facial expression of interest, or a snapshot of the user or avatar with the facial expression of interest has been previously captured, process 700 may return to block 702, and continue therefrom as earlier described to analyze a next image frame. Operations at bock 702 to block 706 may be repeated any number of times for as long as there are image frames captured/generated.

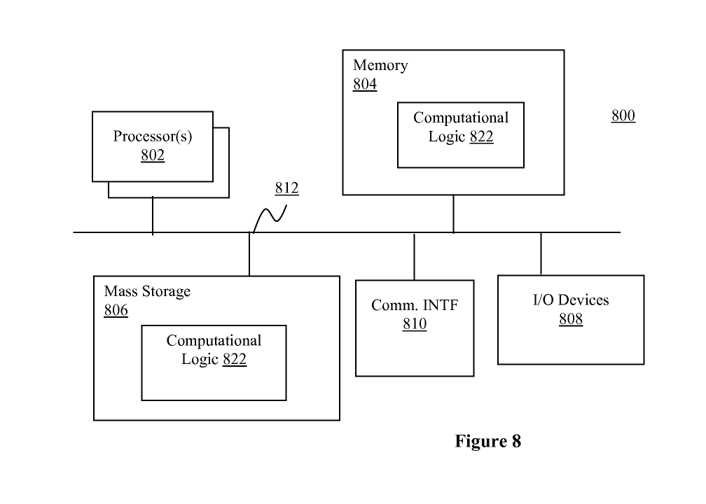

FIG. 8 illustrates an example computer system that may be suitable for use to practice selected aspects of the present disclosure. As shown, computer 800 may include one or more processors or processor cores 802, and system memory 804. For the purpose of this application, including the claims, the terms “processor” and “processor cores” may be considered synonymous, unless the context clearly requires otherwise. Additionally, computer 800 may include mass storage devices 806 (such as diskette, hard drive, compact disc read only memory (CD-ROM) and so forth), input/output devices 808 (such as display, keyboard, cursor control and so forth) and communication interfaces 610 (such as network interface cards, modems and so forth). The elements may be coupled to each other via system bus 812, which may represent one or more buses. In the case of multiple buses, they may be bridged by one or more bus bridges (not shown).

Each of these elements may perform its conventional functions known in the art. In particular, system memory 804 and mass storage devices 806 may be employed to store a working copy and a permanent copy of the programming instructions implementing the operations associated with face tracker 102, in particular, image capture guiding function 112 and/or snapshot auto capture function 114, earlier described, collectively referred to as computational logic 822. The various elements may be implemented by assembler instructions supported by processor(s) 802 or high-level languages, such as, for example, C, that can be compiled into such instructions.

The number, capability and/or capacity of these elements 810-812 may vary, depending on whether computer 800 is used as a mobile device, a stationary device or a server. When use as mobile device, the capability and/or capacity of these elements 810-812 may vary, depending on whether the mobile device is a smartphone, a computing tablet, an ultrabook or a laptop. Otherwise, the constitutions of elements 810-812 are known, and accordingly will not be further described.

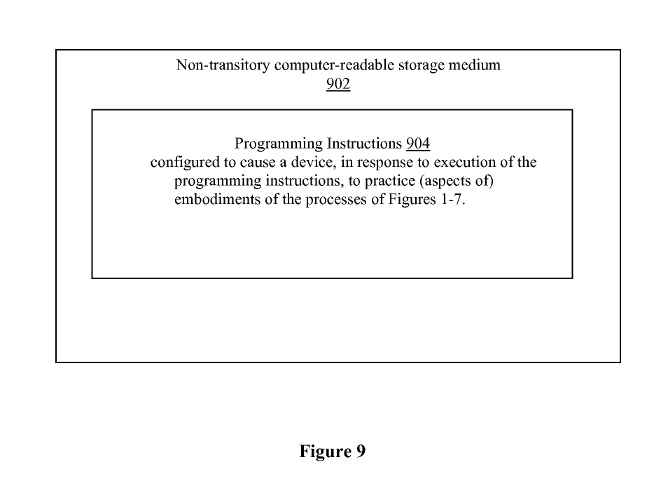

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium. FIG. 9 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 902 may include a number of programming instructions 904. Programming instructions 904 may be configured to enable a device, e.g., computer 800, in response to execution of the programming instructions, to perform, e.g., various operations associated with face tracker 102, in particular, image capture guiding function 112 and/or snapshot auto capture function 114. In alternate embodiments, programming instructions 904 may be disposed on multiple computer-readable non-transitory storage media 902 instead. In alternate embodiments, programming instructions 904 may be disposed on computer-readable transitory storage media 902, such as, signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

Embodiments may be implemented as a computer process, a computing system or as an article of manufacture such as a computer program product of computer readable media. The computer program product may be a computer storage medium readable by a computer system and encoding a computer program instructions for executing a computer process.

The corresponding structures, material, acts, and equivalents of all means or steps plus function elements in the claims below are intended to include any structure, material or act for performing the function in combination with other claimed elements are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment was chosen and described in order to best explain the principles of the disclosure and the practical application, and to enable others of ordinary skill in the art to understand the disclosure for embodiments with various modifications as are suited to the particular use contemplated.

Referring back to FIG. 8, for one embodiment, at least one of processors 802 may be packaged together with memory having computational logic 822 (in lieu of storing on memory 804 and storage 806). For one embodiment, at least one of processors 802 may be packaged together with memory having computational logic 822 to form a System in Package (SiP). For one embodiment, at least one of processors 802 may be integrated on the same die with memory having computational logic 822. For one embodiment, at least one of processors 802 may be packaged together with memory having computational logic 822 to form a System on Chip (SoC). For at least one embodiment, the SoC may be utilized in, e.g., but not limited to, a smartphone or computing tablet.

Thus various example embodiments of the present disclosure have been described including, but are not limited to:

Example 1 may be an apparatus for capturing or generating image. The apparatus may comprise an image capturing engine; and a face tracker coupled with the image capturing engine. The face tracker may be configured to receive an image frame from the image capturing engine, analyze the image frame for a face, and on identification of a face in the image frame, evaluate the face to determine whether the image frame comprises an acceptable or unacceptable face pose. On determination of the image frame having an unacceptable face pose, the face tracker may further provide instructions for taking another image frame, with the instructions designed to improve likelihood that the other image frame will comprise an acceptable face pose.

Example 2 may be example 1, wherein the face tracker, as part of evaluation of the face pose, may determine a plurality of translation positions or a plurality of angles of the face pose.

Example 3 may be example 2, wherein the face tracker, as part of evaluation of the face pose, may first determine a plurality of landmarks of the face, and then determine the plurality of translation positions or the plurality of angles of the face pose, based at least in part on the determined landmarks.

Example 4 may be example 2, wherein the face tracker, as part of evaluation of the face pose, may further determine whether the plurality of translation positions or the plurality of angles for the face pose are within corresponding ranges for the translation positions and the angles.

Example 5 may be example 4, wherein the face tracker may provide the instructions, on determination that at least one of the plurality of translation positions or the plurality of angles is out of a corresponding range for the translation position or angle.

Example 6 may be any one of examples 1-5, wherein the face tracker may instruct rotating the apparatus towards or away from a user, in a clockwise or counterclockwise direction, or to a left or right direction, prior to taking another image frame.

Example 7 may be any one of examples 1-5, wherein the face tracker may instruct moving the apparatus along an X-axis, a Y-axis or a Z-axis, in a positive or negative direction, prior to taking another image frame.

Example 8 may be any one of examples 1-7, wherein the face tracker may further receive a second image frame from either the image capturing engine or an image generating engine, analyze the second image frame for a second face, and on identification of a second face in the second image frame, extract a face shape of the second face or determine a facial expression of the second face, and make a determination on whether to automatically add the second image frame or an avatar image generated based at least in part on the second image frame to a collection of snapshots. The determination may be based at least in part of the extracted face shape or the determined facial expression of the second face in the second image frame.

Example 9 may be example 8, wherein the face tracker, on identification of a second face in the second image frame, may extract a face shape of the second face; wherein the face tracker is also to initialize the collection of snapshots with a snapshot having a third face with a neutral face shape.

Example 10 may be example 9, wherein the face tracker, as part of making the determination, may select a snapshot within the collection of snapshots that has a fourth face that is closest to the second face in the second image frame.

Example 11 may be example 10, wherein the face tracker, as part of making the determination, may further compute a dissimilarity measure between the face shape of the second face in the second image frame, and the face shape of the fourth face in the selected snapshot.

Example 12 may be example 11, wherein the face tracker, as part of making the determination, may further determine whether the dissimilarity measure exceeds a threshold.

Example 13 may be example 12, wherein the face tracker may automatically add the second image frame or an avatar image generated based at least in part on the second image frame to the collection of snapshots on determination that the dissimilarity measure exceeded the threshold.

Example 14 may be example 8, wherein the face tracker, on identification of a second face in the second image frame, may determine a facial expression of the second face. The face tracker may also determine whether the determined facial expression of the second face is a facial expression of interest.

Example 15 may be example 14, wherein the face tracker may automatically add the second image frame or an avatar image generated based at least in part on the second image frame to the collection of snapshots on determination that the determined facial expression is a facial expression of interest.

Example 16 may be an apparatus for capturing or generating image. The apparatus may comprise an image capturing or generating engine; and a face tracker coupled with the image capturing or generating engine. The face tracker may be configured to receive an image frame from the image capturing or generating engine, analyze the image frame for a face, and on identification of a face in the image frame, extract a face shape of the face or determine a facial expression of the face. The face tracker may further make a determination on whether to automatically add the image frame or an avatar image generated based at least in part on the image frame to a collection of snapshots. The determination may be based at least in part of the extracted face shape or the determined facial expression of the face in the image frame.

Example 17 may be example 16, wherein the face tracker, on identification of a face in the image frame, may extract a face shape of the face. The face tracker may also initialize the collection of snapshots with a snapshot having a face with a neutral face shape.

Example 18 may be example 17, wherein the face tracker, as part of making the determination, may select a snapshot within the collection of snapshots that has a face that is closest to the face in the image frame.

Example 19 may be example 18, wherein the face tracker, as part of making the determination, may further compute a dissimilarity measure between the face shape of the face in the image frame, and the face shape of the face in the selected snapshot.

Example 20 may be example 19, wherein the face tracker, as part of making the determination, may further determine whether the dissimilarity measure exceeds a threshold.

Example 21 may be example 20, wherein the face tracker may automatically add the image frame or an avatar image generated based at least in part on the image frame to the collection of snapshots on determination that the dissimilarity measure exceeded the threshold.

Example 21 may be any one of examples 16-21, wherein the face tracker, on identification of a face in the image frame, may determine a facial expression of the face. The face tracker may also determine whether the determined facial expression of the face is a facial expression of interest.

Example 23 may be example 22, wherein the face tracker may automatically add the image frame or an avatar image generated based at least in part on the image frame to the collection of snapshots on determination that the determined facial expression is a facial expression of interest.

Example 24 may be a method for capturing or generating an image. The method may comprise: receiving, by a face tracker of an image capturing or generating apparatus, an image frame; analyzing the image frame, by the face tracker, for a face; on identification of a face in the image frame, evaluating the face, by the face tracker, to determine whether the image frame comprises an acceptable or unacceptable face pose; and on determination of the image frame having an unacceptable face pose, providing, by the face tracker, instructions for taking another image frame, with the instructions designed to improve likelihood that the other image frame will comprise an acceptable face pose.

Example 25 may be example 24, wherein evaluating may comprise determining a plurality of translation positions or a plurality of angles of the face pose.

Example 26 may be example 25, wherein evaluating may comprise first determining a plurality of landmarks of the face, and then determining the plurality of translation positions or the plurality of angles of the face pose, based at least in part on the determined landmarks.

Example 27 may be example 25, wherein evaluating may comprise determining whether the plurality of translation positions or the plurality of angles for the face pose are within corresponding ranges for the translation positions and the angles.

Example 28 may be example 27, wherein providing instructions may comprise providing the instructions, on determining that at least one of the plurality of translation positions or the plurality of angles is out of a corresponding range for the translation position or angle.

Example 29 may be any one of examples 24-28, wherein providing instructions may comprise providing instructions to rotate the apparatus towards or away from a user, in a clockwise or counterclockwise direction, or to a left or right direction, prior to taking another image frame.

Example 30 may be any one of examples 24-28, wherein providing instructions may comprise providing instructions to move the apparatus along an X-axis, a Y-axis or a Z-axis, in a positive or negative direction, prior to taking another image frame.

Example 31 may be any one of examples 24-30, further comprising receiving, by the face tracker, a second image frame; analyzing, by the face tracker, the second image frame for a second face; on identification of a second face in the second image frame, extracting, by the face tracker, a face shape of the second face or determining, by the face tracker, a facial expression of the second face; and determining, by the face tracker, whether to automatically add the second image frame or an avatar image generated based at least in part on the second image frame to a collection of snapshots. Further, determining may be based at least in part of the extracted face shape or the determined facial expression of the second face in the second image frame.

Example 32 may be example 31, further comprising, initializing, by the face tracker, the collection of snapshots with a snapshot having a third face with a neutral face shape; and on identification of a second face in the second image frame, extracting by the face tracker, a face shape of the second face.

Example 33 may be example 32, wherein determining whether to automatically add the second image frame to a collection of snapshots may comprise selecting a snapshot within the collection of snapshots that has a fourth face that is closest to the second face in the second image frame.

Example 34 may be example 33, wherein determining whether to automatically add the second image frame to a collection of snapshots may further comprise computing a dissimilarity measure between the face shape of the second face in the second image frame, and the face shape of the fourth face in the selected snapshot.

Example 35 may be example 34, wherein determining whether to automatically add the second image frame to a collection of snapshots may further comprise determining whether the dissimilarity measure exceeds a threshold.

Example 36 may be example 35, further comprising automatically adding, by the face tracker, the second image frame or an avatar image generated based at least in part on the second image frame to the collection of snapshots on determination that the dissimilarity measure exceeded the threshold.

Example 37 may be example 31, further comprising, on identification of a second face in the second image frame, determining, by the face tracker, a facial expression of the second face, including determining whether the determined facial expression of the second face is a facial expression of interest.

Example 38 may be example 37, further comprising automatically adding, by the face tracker, the second image frame or an avatar image generated based at least in part on the second image frame to the collection of snapshots on determination that the determined facial expression is a facial expression of interest.

Example 39 may be a method for capturing or generating an image. The method may comprise: receiving, by a face tracker of an image capturing or generating apparatus, an image frame; analyzing, by the face tracker, the image frame for a face; on identification of a face in the image frame, extracting, by the face tracker, a face shape of the face or determining, by the face tracker, a facial expression of the face; and determining, by the face tracker, whether to automatically add the image frame or an avatar image generated based at least in part on the image frame to a collection of snapshots, wherein the determination is based at least in part of the extracted face shape or the determined facial expression of the face in the image frame.

Example 40 may be example 39, further comprising, initializing, by the face tracker, the collection of snapshots with a snapshot having a face with a neutral face shape; and on identification of a face in the image frame, extracting, by the face tracker, a face shape of the face.

Example 41 may be example 40, wherein determining whether to automatically add the second image to a collection of snapshots may further comprise selecting a snapshot within the collection of snapshots that has a face that is closest to the face in the image frame.

Example 42 may be example 41, wherein determining whether to automatically add the second image to a collection of snapshots may further comprise computing a dissimilarity measure between the face shape of the face in the image frame, and the face shape of the face in the selected snapshot.

Example 43 may be example 42, wherein determining whether to automatically add the second image to a collection of snapshots may further comprise determining whether the dissimilarity measure exceeds a threshold.

Example 44 may be example 43, further comprising automatically adding, by the face tracker, the image frame or an avatar image generated based at least in part on the image frame to the collection of snapshots on determining that the dissimilarity measure exceeded the threshold.

Example 45 may be any one of examples 39-44, further comprising, on identification of a face in the image frame, determining, by the face tracker, a facial expression of the face; wherein the face tracker is also to determine whether the determined facial expression of the face is a facial expression of interest.

Example 46 may be example 45, further comprising automatically adding, by the face tracker, the image frame or an avatar image generated based at least in part on the image frame to the collection of snapshots on determination that the determined facial expression is a facial expression of interest.

Example 47 may be at least one computer-readable medium having instructions to cause an image capturing or generating apparatus, in response to execution of the instructions by the apparatus, to implement a face tracker. The face tracker may receive an image frame from the image capturing engine, analyze the image frame for a face, and on identification of a face in the image frame, evaluate the face to determine whether the image frame comprises an acceptable or unacceptable face pose. On determination of the image frame having an unacceptable face pose, the face tracker may further provide instructions for taking another image frame, with the instructions designed to improve likelihood that the other image frame will comprise an acceptable face pose.

Example 48 may be example 47, wherein the face tracker, as part of evaluation of the face pose, may determine a plurality of translation positions or a plurality of angles of the face pose.

Example 49 may be example 48, wherein the face tracker, as part of evaluation of the face pose, may first determine a plurality of landmarks of the face, and then determine the plurality of translation positions or the plurality of angles of the face pose, based at least in part on the determined landmarks.

Example 50 may be example 48, wherein the face tracker, as part of evaluation of the face pose, may further determine whether the plurality of translation positions or the plurality of angles for the face pose are within corresponding ranges for the translation positions and the angles.

Example 51 may be example 50, wherein the face tracker may provide the instructions, on determination that at least one of the plurality of translation positions or the plurality of angles is out of a corresponding range for the translation position or angle.

Example 52 may be any one of examples 47-51, wherein the face tracker may instruct rotating the apparatus towards or away from a user, in a clockwise or counterclockwise direction, or to a left or right direction, prior to taking another image frame.

Example 53 may be any one of examples 47-51, wherein the face tracker may instruct moving the apparatus along an X-axis, a Y-axis or a Z-axis, in a positive or negative direction, prior to taking another image frame.

Example 54 may be any one of examples 47-53, wherein the face tracker may further receive a second image frame from either the image capturing engine or an image generating engine, analyze the second image frame for a second face, and on identification of a second face in the second image frame, extract a face shape of the second face or determine a facial expression of the second face, and make a determination on whether to automatically add the second image frame or an avatar image generated based at least in part on the image frame to a collection of snapshots. Further, the determination may be based at least in part of the extracted face shape or the determined facial expression of the second face in the second image frame.

Example 55 may be example 54, wherein the face tracker, on identification of a second face in the second image frame, may extract a face shape of the second face. Further, the face tracker may also initialize the collection of snapshots with a snapshot having a third face with a neutral face shape.

Example 56 may be example 55, wherein the face tracker, as part of making the determination, may select a snapshot within the collection of snapshots that has a fourth face that is closest to the second face in the second image frame.

Example 57 may be example 56, wherein the face tracker, as part of making the determination, may further compute a dissimilarity measure between the face shape of the second face in the second image frame, and the face shape of the fourth face in the selected snapshot.

Example 58 may be example 57, wherein the face tracker, as part of making the determination, may further determine whether the dissimilarity measure exceeds a threshold.

Example 59 may be example 58, wherein the face tracker may automatically add the second image frame or an avatar image generated based at least in part on the second image frame to the collection of snapshots on determination that the dissimilarity measure exceeded the threshold.

Example 60 may be example 54, wherein the face tracker, on identification of a second face in the second image frame, may determine a facial expression of the second face; wherein the face tracker is also to determine whether the determined facial expression of the second face is a facial expression of interest.

Example 61 may be example 60, wherein the face tracker may automatically add the second image frame or an avatar image generated based at least in part on the second image frame to the collection of snapshots on determination that the determined facial expression is a facial expression of interest.

Example 62 may be at least one computer-readable medium having instructions to cause an image capturing or generating apparatus, in response to execution of the instructions by the apparatus, to implement a face tracker. The face tracker may receive an image frame from the image capturing or generating engine, analyze the image frame for a face, and on identification of a face in the image frame, extract a face shape of the face or determine a facial expression of the face; wherein the face tracker is to further make a determination on whether to automatically add the image frame or an avatar image generated based at least in part on the image frame to a collection of snapshots. The determination may be based at least in part of the extracted face shape or the determined facial expression of the face in the image frame.

Example 63 may be example 62, wherein the face tracker, on identification of a face in the image frame, may extract a face shape of the face; wherein the face tracker is also to initialize the collection of snapshots with a snapshot having a face with a neutral face shape.

Example 64 may be example 63, wherein the face tracker, as part of making the determination, may select a snapshot within the collection of snapshots that has a face that is closest to the face in the image frame.

Example 65 may be example 64, wherein the face tracker, as part of making the determination, may further compute a dissimilarity measure between the face shape of the face in the image frame, and the face shape of the face in the selected snapshot.

Example 66 may be example 65, wherein the face tracker, as part of making the determination, may further determine whether the dissimilarity measure exceeds a threshold.

Example 67 may be example 66, wherein the face tracker may automatically add the image frame or an avatar image generated based at least in part on the image frame to the collection of snapshots on determination that the dissimilarity measure exceeded the threshold.

Example 68 may be any one of examples 62-67, wherein the face tracker, on identification of a face in the image frame, may determine a facial expression of the face; wherein the face tracker is also to determine whether the determined facial expression of the face is a facial expression of interest.

Example 69 may be example 68, wherein the face tracker may automatically add the image frame or an avatar image generated based at least in part on the image frame to the collection of snapshots on determination that the determined facial expression is a facial expression of interest.

Example 70 may be an apparatus for capturing or generating image. The apparatus may comprise: an image capturing engine; and face tracking means for receiving an image frame, analyzing the image frame for a face, and on identification of a face in the image frame, evaluating the face to determine whether the image frame comprises an acceptable or unacceptable face pose; and providing instructions for taking another image frame, on determining that the image frame having an unacceptable face pose, with the instructions designed to improve likelihood that the other image frame will comprise an acceptable face pose.

Example 71 may be example 70, wherein the face tracking means may comprise means for determining, as part of evaluation of the face pose, a plurality of translation positions or a plurality of angles of the face pose.

Example 72 may be example 71, wherein the face tracking means may comprise means for first determining, as part of evaluation of the face pose, a plurality of landmarks of the face, and then determining the plurality of translation positions or the plurality of angles of the face pose, based at least in part on the determined landmarks.

Example 73 may be example 71, wherein the face tracking means may comprise means for determining, as part of evaluation of the face pose, whether the plurality of translation positions or the plurality of angles for the face pose are within corresponding ranges for the translation positions and the angles.

Example 74 may be example 73, wherein the face tracking means may comprise means for providing the instructions, on determining that at least one of the plurality of translation positions or the plurality of angles is out of a corresponding range for the translation position or angle.

Example 75 may be any one of examples 70-74, wherein the face tracking means may comprise means for instructing rotating the apparatus towards or away from a user, in a clockwise or counterclockwise direction, or to a left or right direction, prior to taking another image frame.

Example 76 may be any one of examples 70-74, wherein the face tracking means may comprise means for instructing moving the apparatus along an X-axis, a Y-axis or a Z-axis, in a positive or negative direction, prior to taking another image frame.

Example 77 may be any one of examples 70-76, wherein the face tracking means may comprise means for receiving a second image frame, analyzing the second image frame for a second face, and on identification of a second face in the second image frame, extracting a face shape of the second face or determining a facial expression of the second face, and determining whether to automatically add the second image frame or an avatar image generated based at least in part on the second image frame to a collection of snapshots. Further, determining may be based at least in part of the extracted face shape or the determined facial expression of the second face in the second image frame.

Example 78 may be example 77, wherein the face tracking means may comprise means for extracting, on identification of a second face in the second image frame, a face shape of the second face; wherein the face tracker is also to initialize the collection of snapshots with a snapshot having a third face with a neutral face shape.

Example 79 may be example 78, wherein the face tracking means may comprise means for selecting, as part of making the determination, a snapshot within the collection of snapshots that has a fourth face that is closest to the second face in the second image frame.

Example 80 may be example 79, wherein the face tracking means may comprise means for computing, as part of determining whether to automatically add, a dissimilarity measure between the face shape of the second face in the second image frame, and the face shape of the fourth face in the selected snapshot.

Example 81 may be example 80, wherein the face tracking means may comprise means for determining, as part of determining whether to automatically add, whether the dissimilarity measure exceeds a threshold.

Example 82 may be example 81, wherein the face tracking means may comprise means for automatically adding the second image frame or an avatar image generated based at least in part on the second image frame to the collection of snapshots on determination that the dissimilarity measure exceeded the threshold.

Example 83 may be example 77, wherein the face tracking means may comprise means for determining, on identification of a second face in the second image frame, a facial expression of the second face; and means for determining whether the determined facial expression of the second face is a facial expression of interest.

Example 84 may be example 83, wherein the face tracking means may comprise means for automatically adding the second image frame or an avatar image generated based at least in part on the second image frame to the collection of snapshots on determining that the determined facial expression is a facial expression of interest.

Example 85 may be an image capturing or generating apparatus, comprising: an image capturing or generating engine; and face tracking means for receiving an image frame, analyzing the image frame for a face, and on identification of a face in the image frame, extracting a face shape of the face or determine a facial expression of the face; and determining whether to automatically add the image frame or an avatar image generated based at least in part on the image frame to a collection of snapshots, and wherein determining is based at least in part of the extracted face shape or the determined facial expression of the face in the image frame.

Example 86 may be example 85, wherein the face tracking means may comprise means for initializing the collection of snapshots with a snapshot having a face with a neutral face shape; and means for extracting, on identification of a face in the image frame, a face shape of the face.

Example 87 may be example 86, wherein the face tracking means may comprise means for selecting, as part of determining whether to automatically add, a snapshot within the collection of snapshots that has a face that is closest to the face in the image frame.

Example 88 may be example 87, wherein the face tracking means may comprise means for computing, as part of determining whether to automatically add, a dissimilarity measure between the face shape of the face in the image frame, and the face shape of the face in the selected snapshot.

Example 89 may be example 88, wherein the face tracking means may comprise means for determining, as part of determining whether to automatically add, whether the dissimilarity measure exceeds a threshold.

Example 90 may be example 89, wherein the face tracking means may comprise means for automatically adding the image frame or an avatar image generated based at least in part on the image frame to the collection of snapshots on determination that the dissimilarity measure exceeded the threshold.

Example 91 may be any one of examples 85-90, wherein the face tracking means may comprise means for determining, on identification of a face in the image frame, a facial expression of the face; and means for determining whether the determined facial expression of the face is a facial expression of interest.

Example 92 may be example 91, wherein the face tracking means may comprise means for automatically adding the image frame or an avatar image generated based at least in part on the image frame to the collection of snapshots on determination that the determined facial expression is a facial expression of interest.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

1. An apparatus for capturing or generating image, comprising:
an image capturing engine; and
a face tracker coupled with the image capturing engine to receive an image frame from the image capturing engine, analyze the image frame for a face, and on identification of a face in the image frame, evaluate the face to determine whether the image frame comprises an acceptable or unacceptable face pose; wherein on determination of the image frame having an unacceptable face pose, the face tracker is to further provide instructions for taking another image frame, with the instructions designed to improve likelihood that the other image frame will comprise an acceptable face pose.

2. The apparatus of claim 1, wherein the face tracker, as part of evaluation of the face pose, is to first determine a plurality of landmarks of the face, second determine a plurality of translation positions or the plurality of angles of the face pose, based at least in part on the determined landmarks; then third determine whether the plurality of translation positions or the plurality of angles for the face pose are within corresponding ranges for the translation positions and the angles.

3. The apparatus of claim 2, wherein the face tracker is to provide the instructions, on determination that at least one of the plurality of translation positions or the plurality of angles is out of a corresponding range for the translation position or angle.

4. The apparatus of claim 1, wherein the face tracker is to instruct rotating the apparatus towards or away from a user, in a clockwise or counterclockwise direction, or to a left or right direction, prior to taking another image frame; or to instruct moving the apparatus along an X-axis, a Y-axis or a Z-axis, in a positive or negative direction, prior to taking another image frame.

5. The apparatus of claim 1, wherein the face tracker is to further receive a second image frame from either the image capturing engine or an image generating engine, analyze the second image frame for a second face, and on identification of a second face in the second image frame, extract a face shape of the second face or determine a facial expression of the second face, and make a determination on whether to automatically add the second image frame or an avatar image generated based at least in part on the second image frame to a collection of snapshots; wherein the determination is based at least in part of the extracted face shape or the determined facial expression of the second face in the second image frame.

6. An apparatus for capturing or generating image, comprising:
an image capturing or generating engine; and
a face tracker coupled with the image capturing or generating engine to receive an image frame from the image capturing or generating engine, analyze the image frame for a face, and on identification of a face in the image frame, extract a face shape of the face or determine a facial expression of the face; wherein the face tracker is to further make a determination on whether to automatically add the image frame or an avatar image generated based at least in part on the image frame to a collection of snapshots, and wherein the determination is based at least in part of the extracted face shape or the determined facial expression of the face in the image frame.

7. The apparatus of claim 6, wherein the face tracker, on identification of a face in the image frame, is to extract a face shape of the face; wherein the face tracker is also to initialize the collection of snapshots with a snapshot having a face with a neutral face shape.

8. The apparatus of claim 7, wherein the face tracker, as part of making the determination, is to select a snapshot within the collection of snapshots that has a face that is closest to the face in the image frame.

9. The apparatus of claim 8, wherein the face tracker, as part of making the determination, is to further compute a dissimilarity measure between the face shape of the face in the image frame, and the face shape of the face in the selected snapshot.

10. The apparatus of claim 9, wherein the face tracker, as part of making the determination, is to further determine whether the dissimilarity measure exceeds a threshold.

11. The apparatus of claim 10, wherein the face tracker automatically adds the image frame or an avatar image generated based at least in part on the image frame to the collection of snapshots on determination that the dissimilarity measure exceeded the threshold.

12. The apparatus claim 6, wherein the face tracker, on identification of a face in the image frame, is to determine a facial expression of the face; wherein the face tracker is also to determine whether the determined facial expression of the face is a facial expression of interest.

13. The apparatus of claim 12, wherein the face tracker automatically adds the image frame or an avatar image generated based at least in part on the image frame to the collection of snapshots on determination that the determined facial expression is a facial expression of interest.

14. A method for capturing or generating an image, comprising:
receiving, by a face tracker of an image capturing or generating apparatus, an image frame;
analyzing the image frame, by the face tracker, for a face;
on identification of a face in the image frame, evaluating the face, by the face tracker, to determine whether the image frame comprises an acceptable or unacceptable face pose; and
on determination of the image frame having an unacceptable face pose, providing, by the face tracker, instructions for taking another image frame, with the instructions designed to improve likelihood that the other image frame will comprise an acceptable face pose.

15. The method of claim 14, further comprising receiving, by the face tracker, a second image frame; analyzing, by the face tracker, the second image frame for a second face; on identification of a second face in the second image frame, extracting, by the face tracker, a face shape of the second face or determining, by the face tracker, a facial expression of the second face; and determining, by the face tracker, whether to automatically add the second image frame or an avatar image generated based at least in part on the second image frame to a collection of snapshots; wherein determining is based at least in part of the extracted face shape or the determined facial expression of the second face in the second image frame.

16. A method for capturing or generating an image, comprising:
receiving, by a face tracker of an image capturing or generating apparatus, an image frame;
analyzing, by the face tracker, the image frame for a face;
on identification of a face in the image frame, extracting, by the face tracker, a face shape of the face or determining, by the face tracker, a facial expression of the face; and
determining, by the face tracker, whether to automatically add the image frame or an avatar image generated based at least in part on the image frame to a collection of snapshots, wherein the determination is based at least in part of the extracted face shape or the determined facial expression of the face in the image frame.

17. The method of claim 16, further comprising, initializing, by the face tracker, the collection of snapshots with a snapshot having a face with a neutral face shape; and on identification of a face in the image frame, extracting, by the face tracker, a face shape of the face; wherein determining whether to automatically add the second image frame or an avatar image generated based at least in part on the second image frame to a collection of snapshots further comprises selecting a snapshot within the collection of snapshots that has a face that is closest to the face in the image frame; computing a dissimilarity measure between the face shape of the face in the image frame, and the face shape of the face in the selected snapshot; determining whether the dissimilarity measure exceeds a threshold; and adding, by the face tracker, the image frame to the collection of snapshots on determining that the dissimilarity measure exceeded the threshold.

18. (canceled)

19. The method of claim 16, further comprising, on identification of a face in the image frame, determining, by the face tracker, a facial expression of the face; wherein the face tracker is also to determine whether the determined facial expression of the face is a facial expression of interest; and automatically adding, by the face tracker, the image frame or an avatar image generated based at least in part on the image frame to the collection of snapshots on determination that the determined facial expression is a facial expression of interest.

20. At least one computer-readable medium having instructions to cause an image capturing or generating apparatus, in response to execution of the instructions by the apparatus, to implement a face tracker to receive an image frame from the image capturing engine, analyze the image frame for a face, and on identification of a face in the image frame, evaluate the face to determine whether the image frame comprises an acceptable or unacceptable face pose; wherein on determination of the image frame having an unacceptable face pose, the face tracker is to further provide instructions for taking another image frame, with the instructions designed to improve likelihood that the other image frame will comprise an acceptable face pose.

21. (canceled)

22. (canceled)

23. (canceled)

24. (canceled)

25. (canceled)

26. (canceled)

27. (canceled)

28. (canceled)

29. (canceled)

30. (canceled)

31. The computer-readable medium of claim 20, wherein the face tracker, as part of evaluation of the face pose, is to first determine a plurality of landmarks of the face; second determine the plurality of translation positions or the plurality of angles of the face pose, based at least in part on the determined landmarks; third determine whether the plurality of translation positions or the plurality of angles for the face pose are within corresponding ranges for the translation positions and the angles; and provide the instructions, on determination that at least one of the plurality of translation positions or the plurality of angles is out of a corresponding range for the translation position or angle.

32. The computer-readable medium of claim 20, wherein the face tracker is to instruct rotating the apparatus towards or away from a user, in a clockwise or counterclockwise direction, or to a left or right direction, prior to taking another image frame; or to instruct moving the apparatus along an X-axis, a Y-axis or a Z-axis, in a positive or negative direction, prior to taking another image frame.

33. The computer-readable medium of claim 20, wherein the face tracker is to further receive a second image frame from either the image capturing engine or an image generating engine, analyze the second image frame for a second face, and on identification of a second face in the second image frame, extract a face shape of the second face or determine a facial expression of the second face, and make a determination on whether to add the second image frame to a collection of snapshots; wherein the determination is based at least in part of the extracted face shape or the determined facial expression of the second face in the second image frame.

34. At least one computer-readable medium having instructions to cause an image capturing or generating apparatus, in response to execution of the instructions by the apparatus, to implement a face tracker to receive an image frame from the image capturing or generating engine, analyze the image frame for a face, and on identification of a face in the image frame, extract a face shape of the face or determine a facial expression of the face; wherein the face tracker is to further make a determination on whether to add the image frame to a collection of snapshots, and wherein the determination is based at least in part of the extracted face shape or the determined facial expression of the face in the image frame.

35. The computer-readable medium of claim 34, wherein the face tracker, on identification of a face in the image frame, is to extract a face shape of the face; wherein the face tracker is also to initialize the collection of snapshots with a snapshot having a face with a neutral face shape; and wherein the face tracker, as part of making the determination, is to select a snapshot within the collection of snapshots that has a face that is closest to the face in the image frame, compute a dissimilarity measure between the face shape of the face in the image frame, and the face shape of the face in the selected snapshot, determine whether the dissimilarity measure exceeds a threshold; and wherein the face tracker adds the image frame to the collection of snapshots on determination that the dissimilarity measure exceeded the threshold.

36. The computer-readable medium of claim 34, wherein the face tracker, on identification of a face in the image frame, is to determine a facial expression of the face; wherein the face tracker is also to determine whether the determined facial expression of the face is a facial expression of interest; and wherein the face tracker adds the image frame to the collection of snapshots on determination that the determined facial expression is a facial expression of interest.
